(19) United States
(12) Patent Application Publication
(10) Pub. No.: US 2024/0190244 A1
(43) Pub. Date: Jun. 13, 2024

(54) SYSTEMS AND METHODS FOR ALIGNING VEHICLE CHARGING MECHANISMS WITH INFRASTRUCTURE

(71) Applicant: Proterra Operating Company, Inc., Burlingame, CA (US)

(72) Inventors: Roger INNES, Asheville, NC (US); Michael BOGGESS, Burlingame, CA (US); Pranav TULPULE, Burlingame, CA (US)

(73) Assignee: Proterra Operating Company, Inc., Burlingame, CA (US)

(21) Appl. No.: 18/063,254

(22) Filed: Dec. 8, 2022

(51) Int. Cl. B60K 35/00; B60L 53/14; B60L 53/37

(52) U.S. Cl. CPC B60K 35/00; B60L 53/14; B60L 53/37; B60K 2370/152; B60K 2370/16; B60L 2250/16

(57) ABSTRACT

A method of charging an electric vehicle including: sensing a relative location of a charging head of the electric vehicle with respect to a charging connection of a charging station using one or more sensors; generating relative location information related to the relative location; and displaying information related to the relative location information on a display of the electric vehicle.

### TECHNICAL FIELD

Embodiments of this disclosure relate to systems and methods for charging an electric bus with a charging apparatus and more particularly, to systems and methods for positioning an electric bus with an overhead charging apparatus.

### BACKGROUND

An electric bus (e.g., an electric transit bus) may use unassisted visual alignment to position a vehicle-borne charging connector (e.g., a vehicle side connector (“VSC”)) with a charging-infrastructure-borne charging connector (e.g., an infrastructure side connector (“ISC”)). In some current examples, this may include an operator visually aligning aspects of the transit bus (e.g., a front door) with a portion of the infrastructure. This may require the transit operator to manually position (i.e., park) the bus inside a box to make a proper connection between the vehicle-based and infrastructure-based connectors. However, this approach is prone to mistakes and is often inaccurate as each transit operator has a unique visual reference frame based on various factors such as, for example, seat position, torso height, etc. Additionally, different charging infrastructure configurations may require operators to learn, memorize, and recall various visual reference points on the varying infrastructure. This problem can be further exacerbated by the variation between charging connectors on different buses.

Moreover, electric buses may present difficulties with respect to aligning vehicle-borne and infrastructure-borne charging apparatuses that other electric vehicles do not based on the size and dimensions of an electric transit bus, when compared to standard road infrastructure in both urban and rural environments. For example, lane boundaries (curbs, lane lines, etc.) and other road features may be encountered differently in a bus than in a passenger automobile (e.g., a sedan). Additionally, the locations and arrangement of vehicle-borne features of electric buses (e.g., wheel hubs, doors, windows, cameras, etc.) may present unique challenges.

The solution of this disclosure resolves these and/or other issues of the art.

### SUMMARY

In one embodiment, a method of charging an electric vehicle includes sensing a relative location of a charging head of the electric vehicle with respect to a charging connection of a charging station using one or more sensors; generating relative location information related to the relative location; and displaying information related to the relative location information on a display of the electric vehicle.

In another embodiment, a system for charging an electric vehicle, includes an electric vehicle comprising an electrical system and a rooftop mounted charging head configured to electrically couple with a charging connection of a charging station that comprises an overhead charging arm to charge the electrical system; one or more sensors; a display; and a computing system in communication with the vehicle, the computing system comprising a controller that is operatively coupled to one or more of the one or more sensors and the display, comprising one or more executable instructions that, when executed, cause the system to: sense a relative location of the charging head with respect to the charging connection using one or more of the one or more sensors; generate relative location information related to the relative location; and display information related to the relative location information.

In yet another embodiment, an electric vehicle, includes an electrical system; a mounted charging head for receiving an overhead charging connection of a charging arm to charge one or more batteries of the electrical system; one or more sensors configured to sense a relative location of the charging head with respect to the charging connection; and a controller configured to: capture relative location data from the one or more sensors indicative of a relative location of the electric vehicle charging head with respect to the charging connection; and present information related to the relative location data to an operator of the electric vehicle.

### BRIEF DESCRIPTION OF THE DRAWINGS

The accompanying drawings, which are incorporated in and constitute a part of this specification, illustrate exemplary embodiments of the present disclosure and together with the description, serve to explain the principles of the disclosure.

FIG. 1 depicts a birdseye view of an electric bus in a charging environment according to one or more aspects described herein.

FIG. 2 depicts a front view of the electric bus in the charging environment of FIG. 1.

FIG. 3 depicts an exemplary controller for charging a vehicle, such as the electric bus of FIG. 1.

FIG. 4 depicts a dashboard of an electric vehicle such as the electric bus of FIG. 1.

FIG. 5A depicts an exemplary embodiment for charging an electric bus using one or more of the systems and methods shown and described herein.

FIG. 5B depicts an exemplary embodiment for charging an electric bus using one or more of the systems and methods shown and described herein.

FIG. 6A depicts another exemplary embodiment for charging an electric bus using one or more of the systems and methods described herein.

FIG. 6B depicts an exemplary embodiment of an alignment device for aligning the electric bus of FIG. 6A.

FIG. 7A depicts yet another exemplary embodiment for charging an electric bus using one or more of the systems and methods described herein.

FIG. 7B depicts multiple sensing zones for sensing an electric bus using the exemplary embodiment of FIG. 7A.

FIG. 7C depicts multiple lateral sensing zones for sensing an electric bus using the exemplary embodiment of FIG. 7A.

FIG. 8 is a simplified functional block diagram of a computing system for carrying out one or more of the functions of the embodiments described herein.

### DETAILED DESCRIPTION

The present disclosure describes systems and methods aligning an electric bus with a charging apparatus. While principles of the current disclosure are described with reference to an electric bus, it should be understood that the disclosure is not limited thereto. Rather, the systems of the present disclosure can be used to align any vehicle or system.

In this disclosure, the terms “about,” “substantially,” or “approximate” are used to indicate a potential variation of 10% of a stated value.

Any implementation described herein as exemplary is not to be construed as preferred or advantageous over other implementations. Rather, the term “exemplary” is used in the sense of example or illustrative.

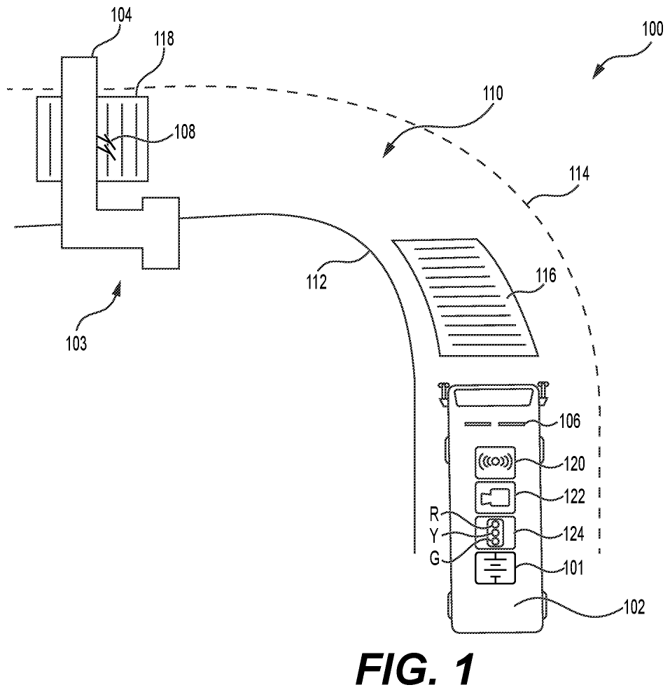

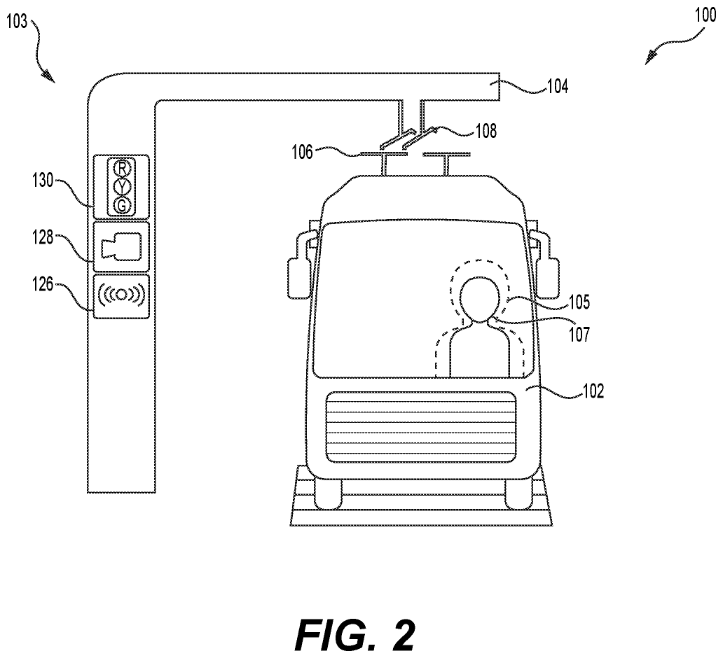

FIGS. 1 and 2 schematically depict a charging system 100 (“system”) for applying electrical power to an electric bus 102 (e.g., for charging a battery system 101, for applying electrical power to an electrical system, etc.) The electric bus 102 may be charged at a charging station 103 including an overhead charging system that includes an arm 104. By way of example and without limitation, the overhead charging system contemplated in this disclosure can be for a roof-mounted configuration, such as an inverted pantograph that interfaces with a set of rails mounted on the forward rooftop of the electric bus 102.

The bus 102 may include a charging head 106 (FIG. 2) which may electrically couple with a charging connection 108 of the charging station 103. The charging head 106 may include an infrastructure-mounted cross rail head (e.g., according to the SAE J3105/1 standard, which is incorporated herein by reference in its entirety). The charging interface may be a vehicle-mounted pantograph that interfaces with the charging head 106 (e.g., a vehicle-mounted panhead that interfaces with an overhead hood according to the SAE J3105/2 standard, which is incorporated herein by reference in its entirety), or the charging head and charging interface may include a pin and socket connection (e.g., according to the SAE J3105/3 standard, which is incorporated herein by reference in its entirety). Examples of various charging heads and charging interfaces, which may be used with certain embodiments described herein, are described and illustrated in U.S. Pat. Nos. 10,875,411 B2, 11,345,245 B2, and 11,351,879 B2, which are incorporated herein by reference in their entirety.

It is noted that the distance between the charging head 106 and the charging connection 108 in FIGS. 1 and 2 is not necessarily to scale, and the two would operatively couple to charge the battery of the bus 102. The charging connection 108 may be, for example, a rail, a double rail, an insert, or some other device that is physically capable of electrically coupling with the charging head 106. The charging station 103 may be electrically coupled with an electric grid and may receive electric power from the electric utility grid for providing electrical energy to the bus 102 through the charging connection 108 to the charging head 106.

The bus 102 may operate in an environment in or adjacent the charging station 103 which includes one or more road features. For example, the environment may include a lane 110 which may be bounded by one or more boundaries including, for example, a curb 112 and a lane line 114. Because the bus 102 may have a relatively long length dimension with respect to a width of the lane 110, the charging system 100 may include one or more features that facilitate alignment of the bus 102 with the arm 104. For example, the lane line 114 may be configured with a greater radius than the curb such that the bus can take a wide turn in order to ensure back wheels of the bus 102 are along the curb when the bus 102 pulls into the charging station 103 such that the charging head 106 is aligned with the charging connection 108.

Additionally, the charging system 100 may include one or more features for aligning the bus 102 accurately within the charging station 103. For example, a primary alignment device 116 and a secondary alignment device 118 can be included with the charging system 100. The primary alignment device 116 and the secondary alignment device 118, described in greater detail herein, may take any form (such as, for example, road markings, lane markings, road signs, etc.) and may serve to ensure proper alignment of the bus 102 as it approaches the charging station 103. Some embodiments of the charging system 100 may have no alignment devices or a different number of alignment devices which may take any form, such as visual, haptic, audible, or other form.

The bus 102 and the charging station 103 may each include various other components and/or features for aligning the bus. In some cases, these components and/or features may serve other purposes with respect to the bus 102 and/or the charging station 103. The bus 102 may include, for example, one or more sensor systems 120 for sending and/or receiving one or more signals from the bus 102. The bus 102 may include, for example, one or more cameras 122 for generating one or more visual images of the environment surrounding the bus 102. In some embodiments, the bus 102 may include one or more alignment devices 124 which may be, for example, embodied in a connected display or other means for presenting related information and data to an operator of the bus 102.

The one or more alignment devices 124 may be configured to show gradated data with respect to a position and/or other aspect of the bus 102 (e.g., the charging head 106) with respect to the charging station 103 and/or components thereof, such as the arm 104 and/or the charging connection 108. For example, a display may show various displayed characteristics based on the relative location of aspects of the charging head 106 with the charging connection 108 (e.g., based on an absolute distance between the two, etc.) In some embodiments, the alignment device 124 may indicate a recommended or required bus performance parameter, such as vehicle speed for alignment between the charging head 106 and the charging connection 108. The alignment device 124 is depicted as a visual representation, but other embodiments are considered. For example, the alignment device may be an audible indication (e.g., over speakers (not shown) of the bus 102) or haptic indication (e.g., a steering wheel (not shown) vibration).

The charging station 103 may include, for example, one or more sensor systems 126 for sending and/or receiving a signal from the charging station 103. The charging station 103 may include, for example, one or more cameras 128 for generating one or more visual images of the environment surrounding the bus 102. In some embodiments, the charging station 103 may include one or more alignment devices 130 which may be, for example, embodied in a display or other means for presenting data to an operator of the bus 102. The alignment device 130 may be configured to show gradated data with respect to a position or other aspect of the bus 102 with respect to the charging station 103. For example, the display 402 may gradate a display based on the relative location of the charging head 106 with the charging connection 108 (e.g., based on an absolute distance between the two, etc.). The alignment device 130 is depicted as a visual representation, but other embodiments are considered. For example, the alignment device may be an audible indication (e.g., over speakers (not shown) of the bus 102) or haptic indication (e.g., a steering wheel vibration).

The sensor systems 120, 126 may be, for example, sensors used to determine a position of the bus 102 with respect to the charging station 103 and may include, for example, ultrasonic, GPS, infrared, radar, lidar, sonar, and/or other type of sensor capable of sending and receiving a signal to determine the position of an object in the space surrounding the sensor. The sensor systems 120 may be positioned at any location on the bus 102 and the position of any particular sensor may be referenced with respect to features of the bus 102. For example, the position of a particular sensor can be referenced with respect to the charging head 106 such that the position of the charging head 106 can be known based on the position of the sensor.

The sensor systems 126 may be positioned at any location of the charging station 103 and the position of any particular sensor may be referenced with respect to features of the charging station 103, for example, with respect to the charging connection 108 such that the position of the charging connection 108 can be known based on the position of the sensor.

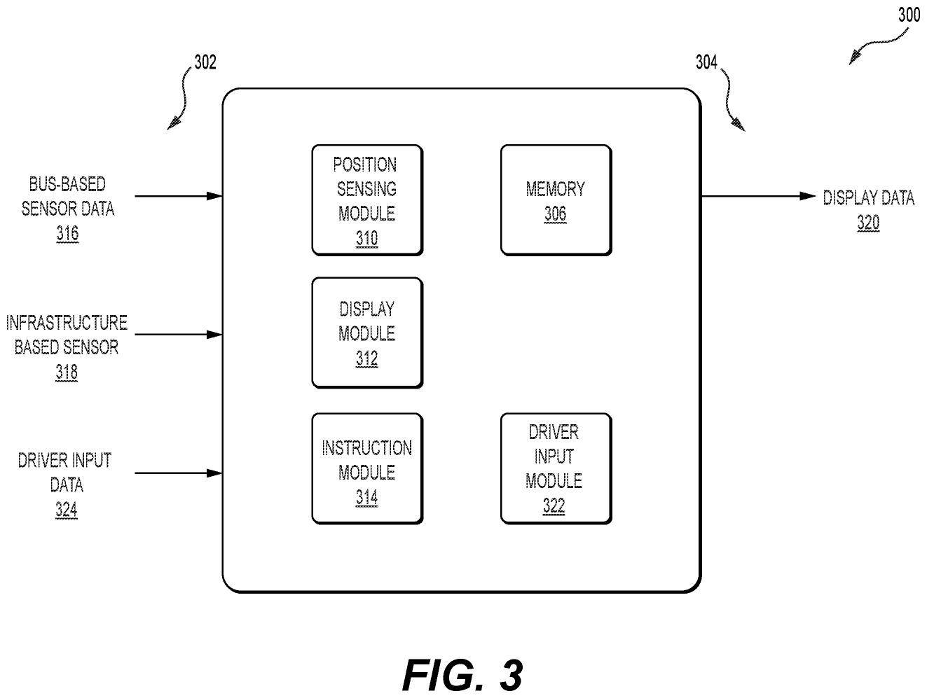

In some aspects, the position of the sensor systems 120, 126 may be provided to a controller (e.g., the controller 300 of FIG. 3 described below) on the bus 102 such that the location of the charging head 106 with respect to the charging connection 108 is known. In some embodiments, the relative location of the charging head 106 with respect to the charging connection 108 may be presented to the operator of the bus 102 with the alignment device 124, 130.

The one or more cameras 122, 128 may be positioned at any position on the bus 102 and the charging station 103, respectively, such that an operator of the bus 102 is assisted with the alignment of the charging head 106 with the charging connection 108 based on visual data. For example, images of the charging head 106 and the charging connection 108 may be depicted visually (e.g., on a display (not shown) inside a cabin (not shown) of the bus 102). The one or more cameras 122 may be, for example, on a roof of the bus 102 and may show the charging connection 108 as it electrically couples with the charging head 106.

In other embodiments, the one or more cameras 122 may be positioned to face downwards or in another direction to detect one or more alignment devices and may align the bus 102 based on detection of the one or more alignment devices. For example, the one or more cameras 122 may be configured to detect the alignment device 118 as the bus 102 moves over the alignment device 118 and recognize, for example, one or more patterns in the alignment device 118, which recognition serves to indicate a relative location of the charging head 106 with the charging connection 108. For example, the alignment device 118 may include a series of indicator elements (e.g., such as increasingly thick stripes) as the bus 102 approaches a fully aligned position. In some aspects, the series of indicator elements may be visibly detectable by the one or more cameras 122. In some embodiments, the features of the alignment device 118 may be visible to the operator of the bus 102 on a display within the cabin of the bus 102.

In some embodiments, the system 100 may further be configured such that that cameras 122 may be used to detect other alignment devices, such as the alignment device 116, which other alignment devices may serve to align the bus 102 before it approaches the charging station 103 to facilitate alignment of the bus 102. Due to their length, it can be difficult to realign a bus approaching an area that requires precise alignment at an improper angle and/or orientation. For example, if the bus pulls into the charging station 103 with its rear wheels too far from the curb 112, it can be difficult to realign the bus 102 with the charging station 103 such that the charging head 106 and the charging connection 108 electrically couple. Accordingly, an operator of the bus 102 may be required to reverse the bus several times or a great distance in order to properly align the bus 102 for charging. This both wastes time and can leads to considerable delays. Accordingly, the solution of this disclosure can include aspects whereby the bus 102 may be configured with one or more cameras 122 that can visibly detect a first alignment device 116 that may be distinct or in preparation for the final alignment device 118. The one or more cameras 122 may capture visual imagery (“visual data”) of the first alignment device. For example, the visual data may be used to determine necessary adjustments to facilitate the alignment of the bus 102 as it approaches the secondary alignment device 118 such that proper alignment between the charging head 106 and the charging connection 108 for charging can occur.

FIG. 3 shows an exemplary controller 300 for controlling one or more aspects of the system 100 of FIGS. 1 and 2. The controller 300 may include various modules which receive one or more signals (inputs 302) and generate one or more signals (outputs 304) based on the received signal(s). The controller 300 may include a position sensing module 310, a display module 312, an instruction module 314, and a driver input module 322. Based on the inputs 302, the controller 300 may generate display data 320 which it may display to an operator of the bus 102 as described in greater detail herein.

The memory 306 may include a memory, a secondary storage device, processor(s), such as central processing unit(s), networking interfaces, or any other means for accomplishing tasks consistent with the present disclosure. The memory or secondary storage device associated with controller 300 may store data and software to allow the controller 300 to perform its functions, including the functions described herein. One or more of the devices or systems communicatively coupled to the controller 300 may be communicatively coupled over a wired or wireless network, such as the Internet, a Local Area Network, WiFi, Bluetooth, or any combination of suitable networking arrangements and protocols.

The position sensing module 310 may receive one or both of the bus-based sensor data 316 and the infrastructure-based sensor data 318 to generate data related to the sensed position of the bus 102. The position sensing module 310 may generate one or more control signals which controls the one or more sensors 120, 126 and the one or more cameras 122, 128. The display module 312 may generate data that may be used to display various information to the driver of the bus 102, such as, for example, a location of the bus 102 with respect to the charging station 103, a visual image of the bus 102, the charging station 103, or various other components of the system 100, or other data. The instruction module 314 may generate various instructions to an operator of the bus 102 which instructions may assist the operator of the bus 102 to locate the bus 102 with respect to the charging station 103. The instructions may include, for example without limitation, “pull forward 4 inches,” “reverse,” and other instructions. These example instructions are merely exemplary and any other instructions to facilitate accurate alignment are contemplated as needed ore required. The driver input module 322 may receive data (e.g., driver input data 324) which may be used to generate display data 320. The driver input data 324 may be captured, for example, using an input feature of a display (e.g., a capacitive interface such as a touchscreen) and may be used to affect the display data 320 displayed to the operator of the bus 102 (e.g., to change a field of view of a camera, acknowledge instructions, etc.) as described in greater detail herein.

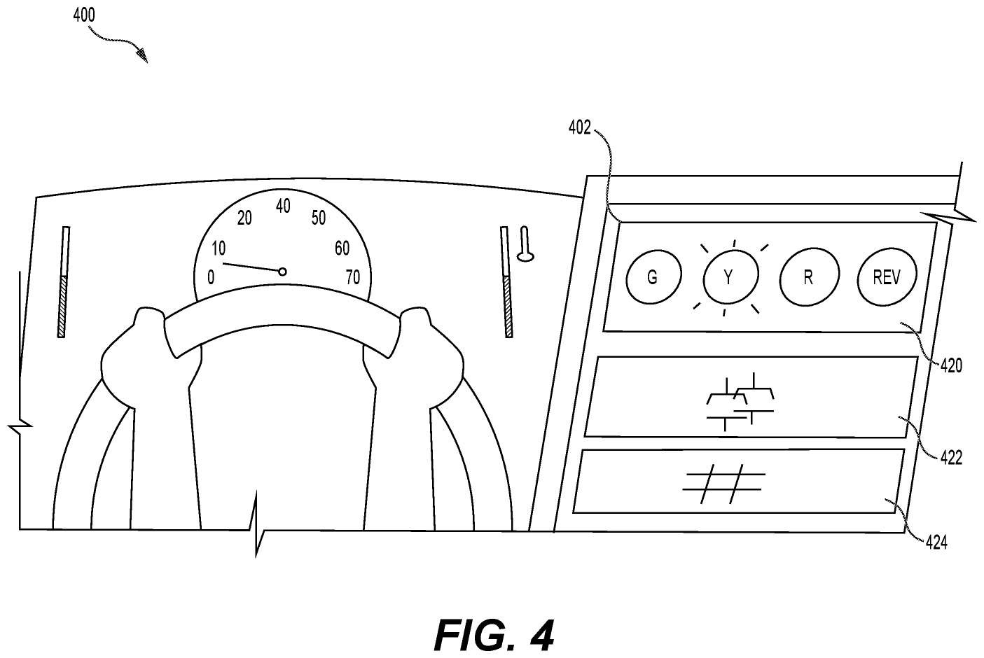

FIG. 4 shows an exemplary dashboard 400 of an electric bus, such as the bus 102 of FIGS. 1 and 2. The exemplary dashboard 400 may include a steering wheel, various gauges indicating operational parameters of the bus 102, and a display 402 for displaying information to the operator of the bus 102, for example, information related to the relative location of the charging head 106 and the charging connection 108 of FIGS. 1 and 2. The display 402 may be divided into multiple sections and each section may display various information. For example, a first section 420 may display one or more colored interfaces indicative of aspects related to the bus 102 (e.g., a green, yellow, red, reverse indication), which indication may be used to assist a driver with aligning the charging head 106 and the charging connection 108 as described in greater detail herein. A second section 422 may display, for example, visual images captured by one or more of the cameras associated with the system 100. A third section 424 may display, for example, visual images of alignment devices, such as the alignment device 118 of FIG. 1, for example. The operator of the bus 102 may generally operate the bus 102 based on a view of the operator from his or her position in the bus 102 through the various windows surrounding the cabin, based on the visual depiction on the display 402, and/or based on other sensory means. In some embodiments, the display 402 may be configured to display one or more overlays or graphics generated based on the visual data captured with the one or more sensors or the one or more cameras, which overlays or graphics may be generated as display data 320 by the controller 300 of FIG. 3. In some embodiments, the controller 300 may be configured to generate one or more renderings based on image or sensor data captured using the cameras and sensors of the system 100. For example, the system 100 may be configured to render a birdseye view of the bus 102 and the charging station 103 using captured imagery from laterally-positioned cameras and/or stored imagery.

The rendered birdseye view may give the operator of the bus 102 an overhead view of the relative location of the charging head 106 and the charging connection 108. In some embodiments, visual data may represent a relative distance from a receptacle such as the charging head 106 of FIG. 1 to an apparatus, such as the charging connection 108 of FIG. 1, using a graphically-rendered receptacle (e.g., rendered as a visual indicator such as a crosshair) and a rendered apparatus (e.g., rendered as another visual indicator such as a dot) and the rendered receptacle may get nearer to the rendered apparatus as the operator moves the charging head 106 towards the charging connection 108 and vice-versa. The relative distance may be displayed on a crosshairs which may indicate some direction to an operator. For instance, the operator may be able to determine, based on the rendered graphic, that he or she should move the bus 102 a particular distance or orientation such that a rendered image representative of the charging head 106 aligns with the rendered image representative of the charging connection 108 (e.g., within an alignment tolerance). In some embodiments, an alignment tolerance may be rendered on the display based on, for example, a number of rings from the center of the cross hairs. In some embodiments, the system 100 may be configured to display instructions to an operator to assist with the alignment. For example, the system 100 may display instructions that may instruct the operator to turn a steering wheel, to drive in a particular direction (e.g., forward, reverse, at an angle, etc.), or to take one or more further actions with the bus 102.

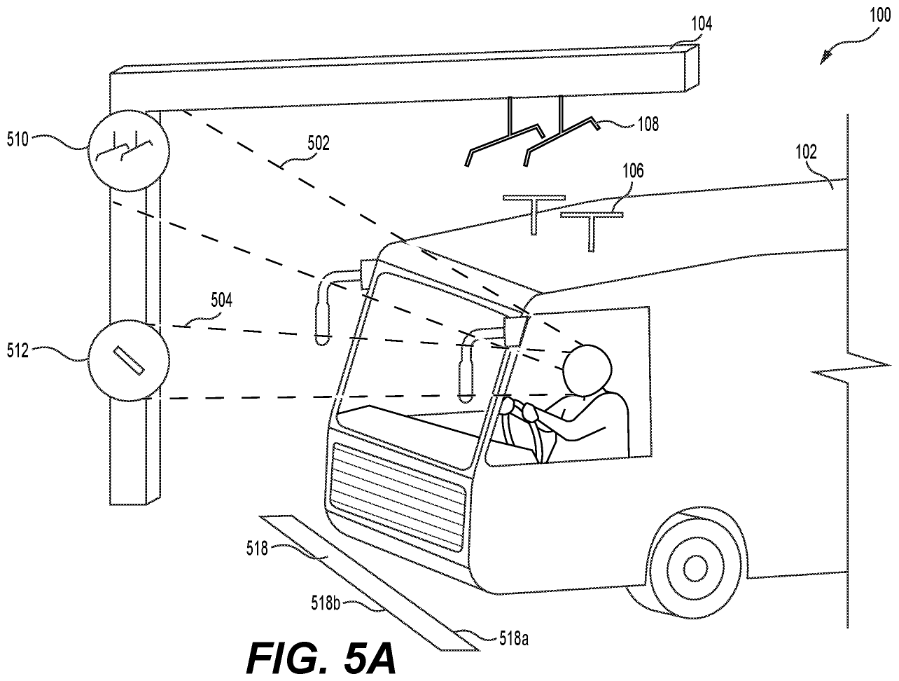

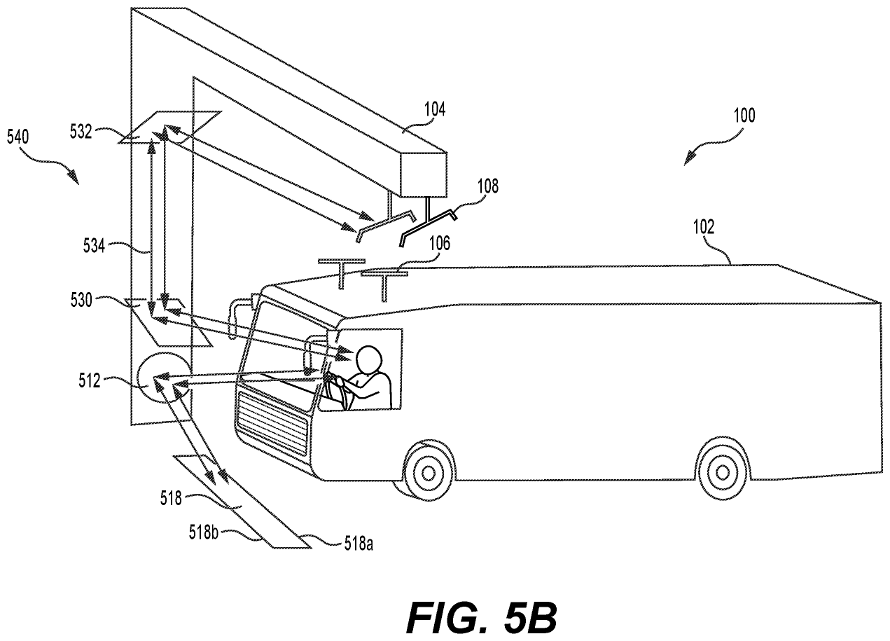

Referring now to FIG. 5A, a particular exemplary embodiment of the system 100 is shown. The system 100 includes the bus 102, the arm 104, the charging head 106, and the charging connection 108. It is noted that the distance between the charging head 106 and the charging connection 108 is not necessarily to scale, and the charging head 106 and the charging connection 108 would operatively couple to charge the battery system of the bus 102). In FIG. 5A, a driver of the bus 102 looks out at the arm 104 with a first point of view 502 and a second point of view 504. The driver may look, for example, at a first mirror 510 and a second mirror 512. The first mirror 510 may be an image assisting device that may be positioned to provide a visual indication of the position of the charging head 106 with respect to the charging connection 108 to the driver of the bus 102. The second mirror 512 may be an image assisting device that may be positioned so as to provide a view of an alignment device 518 which may help the driver of the bus 102 align the bus 102 into the correct location for electrical coupling between the charging head 106 and the charging connection 108. Although shown as a single strip, the alignment device 518 may be any device that is generally perceptible (e.g., visible, tactile, etc.) to the driver and that provides alignment of the bus 102.

Not all embodiments of the system 100 include one or both of the first mirror 510 or the second mirror 512. For example, embodiments which have only one of, or none of, the first mirror 510 and the second mirror 512. In some embodiments, there may be additional mirrors (e.g., a third mirror, fourth mirror, etc.) The mirrors may be in any arrangement and positioned variously between the arm 104 and the surrounding infrastructure or the bus 102. In some embodiments, lenses associated with the first mirror 510 and/or the second mirror 512 may have an orientation that beds the reflected light into the view of the driver. For example, the lens(es) may be concave, convex, or flat. In some embodiments, one or more mirrors may be on a moveable support (e.g., a gimble, a flexible arm, etc.), which may allow for the repositioning of the mirror. In some embodiments, movement of the mirror may be automatic (e.g., using one or more actuators) based on one or more characteristics of the bus, the driver, or other component of the system 100. For example, the system 100 may be configured to automatically adjust an angle or other characteristic of the one or more mirrors based on a height, position, distance to, or other characteristic of the driver or other aspect of the system 100.

For example, with brief reference to FIG. 2, different drivers may have different characteristics, such as a larger driver profile 105 and a smaller driver profile 107. In some embodiments, the system may be configured to adjust based on the driver profile. In some embodiments, the first mirror 510 and the second mirror 512 may automatically adjust based on the driver profile sensed by the various sensors of the system 100. In other embodiments, the first mirror 510 and the second mirror 512 may automatically adjust based on driver profile characteristics stored, for example, in the memory 306 of the controller 300.

The driver may position the bus 102 such that the charging head 106 aligns with the charging connection 108 as the bus moves into position. It is noted that the distance between the charging head 106 and the charging connection 108 is not to scale, and the charging head 106 and the charging connection 108 would operatively couple to charge the battery system of the bus 102. In some embodiments, the alignment device 518 may provide a general reference frame for where the driver should position the bus 102. The alignment device 518 may have a length and a width dimension, for example, which may be visible through the second mirror 512, which length and width dimension may indicate to the driver of the bus 102 where to position the bus 102. In some embodiments, the alignment device 518 may include markings which may be specific to a particular type of bus. For example, the alignment device 518 may have particular markings that tell the driver of a particular class or type of bus where to position the bus with respect to the alignment device. For example, a driver with a first front wheel position relative to a front of a first bus may drive his or her bus to a particular indication 518a and a driver operating a different bus with a second front wheel position relative to a front of a second bus may drive his or her bus to a different indication 518b.

Referring to FIG. 5B, in some embodiments, the system 100 may include a multiple-mirror system 540, which may reflect images of the charging connection 108 through multiple mirrors (e.g., a first mirror 530 and a second mirror 532, which reflection between the two may be possible as demonstrated by light 534) which may make enhance imagery of the charging connection 108. The mirrors of the multiple mirror system 540 may be on mounted such that they can be repositioned, similarly to the first mirror 510 and second mirror 512. The first mirror 530 and the second mirror 512 may be mounted nearer one another, making it easier for a driver of the bus 102 to simultaneously have images from the first mirror 530 and the second mirror 512 in his or her view.

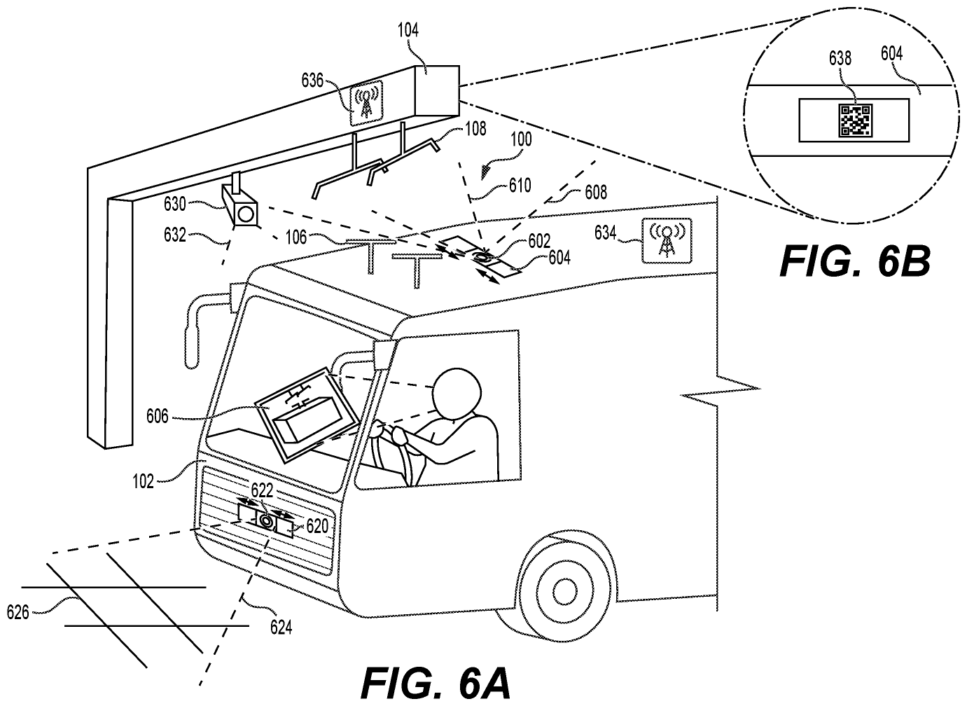

Referring now to FIGS. 6A and 6B, another exemplary embodiment of the system 100 is shown. FIG. 6A shows the bus 102, the arm 104, the charging head 106, and the charging connection 108. It is noted that the distance between the charging head 106 and the charging connection 108 is not to scale, and the charging head 106 and the charging connection 108 would operatively couple to charge the battery system of the bus 102. The bus 102 includes a camera 602 which may be protected by a moveable door 604 or a similar feature such as a wiper for keeping the lens of the camera clear. The system 100 may further include a display 606 for displaying visual information including location data and/or instructions to the operator of the bus 102.

The camera 602 may have any field of view for capturing visual imagery with the camera 602, for example, a narrow field of view 610 and a wide field of view 608. The camera 602 may be configured such that it can capture image data of objects above the bus 102 so that it can be used to position the bus 102 with respect to the arm 104 to align the charging head 106 with the charging connection 108. The bus 102 may have one or more other cameras in addition to or in place of the camera 602, for example, the bus 102 may have a forward-facing camera 622 which may be behind a moveable door 620. The forward-facing camera 622 may, for example, capture image data from ahead of the bus 102 such that it can capture one or more images of an alignment device 626 in a field of view 624. The forward-facing camera 622 may have one or more fields of view in some embodiments (e.g., multiple distinct fields of view, an adjustable field of view, etc.). In some embodiments, the arm 104 may include one or more cameras, such as the camera 630. The camera 630 may be positioned on the arm 104 such that it captures image data including the bus 102 as the bus 102 is positioned under the arm 104 in a field of view 632. The camera 630 may have one or more fields of view in some embodiments (e.g., multiple distinct fields of view, an adjustable field of view, etc.).

The bus 102 and the arm 104 may have communication devices (e.g., WiFi, modems, etc.) such that they can communicate with one another, for example, via a transceiver 634 and a transceiver 636. In some embodiments, image data captured with the camera 630 may be provided to the bus 102 via a connection between the transceiver 636 and the transceiver 634. In some embodiments, both the transceiver 636 and the transceiver 634 may connect to an external network (e.g., the Internet, a cloud network, etc.) and data may be passed over the external network. Image data captured by one or more of the cameras associated with the system 100 (e.g., the camera 602, the camera 622, the camera 630, or other cameras) may be displayed on the display 606.

The cameras can have any optical characteristics (e.g., field of view, zoom, resolution, etc.) such that visual data showing the charging head 106 and the charging connection 108 can be displayed to the driver of the bus 102 or otherwise interpreted by the system 100 to align the charging head 106 and the charging connection 108 for charging the electric bus 102. In some embodiments, one or more of the doors 604 and the doors 620 can open in order to capture image data and shut to protect the cameras from the environment (e.g., rain, dust, etc.) In some embodiments, the doors 604 and the doors 620 may open automatically based on, for example, a position of the bus 102, a signal received from the arm 104 or other charging infrastructure, or other input to the system 100.

With reference to FIGS. 6A and 6B, in some embodiments, an alignment device 638 may be positioned on the arm 104 of the charging system 100. The alignment device 638 may be, for example, a QR code or other device which may be recognized and captured via one or more cameras on the bus 102. For example, the alignment device 638 may be positioned on a bus-facing side of the arm 104 and the camera 602 may capture image data including images of the alignment device 638. Recognition of the alignment device 638 may entail recognition of other information, for example, a location of the charging system 100, a status of the charging system 100 (e.g., functional, operating at minimum or maximum operating voltages, etc.) In some embodiments, recognition of the alignment device 638 may cause one or more actions to occur on the bus 102, for example, opening of the sliding doors 620 or other automated action on the bus 102 (e.g., movement of the driver's seat to a standardized position for aligning the charging head 106 with the charging connection 108, etc.)

In some embodiments, one or more of the cameras 602, 622 is an camera (e.g., infrared or thermal) capable of detecting differences in detected feedback, such as infrared light and/or temperature, and the system 100 may include one or more infrared and/or thermal features for detecting with the cameras 602, 622 in order to align the charging head 106 and the charging connection 108. For example, one or more of the alignment devices may include thermal or infrared components or have thermal or infrared characteristics.

In some embodiments, the system 100 may include one or more features for moving or changing one or more aspects of the cameras. For example, the display 606 may include a user interface with an input/output display and the display 606 may be used to change a zoom level, an angle, a position of the doors 604, 620, or some other aspect of the cameras 602, 622.

The alignment device 626 may include one or more features for aligning the bus 102 such that the charging connection 108 and the charging head 106 can electrically couple. The alignment device can take any shape, for example, the hash shape shown in FIG. 6A, multiple lines, multiple circles, polygons, or other shapes. The features of the alignment device 626 may be displayed on the display 606 and may help the driver align the bus, for example, by pulling to a particular position with respect to the alignment device 626. In some embodiments, the display 606 may display or otherwise provide feedback (e.g., visual, tactile, audible, etc.) to a driver when the bus is aligned properly or to help him or her align the bus. For example, the display 606 may display one or more prompts (e.g., “bus is properly aligned,” “move three feet left,” etc.) or other visual indications on the display. In some embodiments, the alignment device 626 may be recognizable by one or more image recognition algorithms and the display 606 may display one or more instructions to the driver based on the features recognized based on data captured by the camera 622. For example, the system 100 may be configured with a particular adjustment of the alignment device 626 and the display 606 may display instructions to the driver of the bus 102 such that the driver can maneuver the bus 102 into position. For example, the instructions may instruct the driver to, “Pull forward 6 inches,” or “move left 2 inches,” based on recognition and analysis of the imagery captured by the camera 622 of the alignment device 626.

In some embodiments, the camera 602 may alter its field of view based on its location with respect to the charging connection 108. For example, the bus 102 may drive toward the arm 104 until the charging connection 108 are within a field of view 608 of the camera 602. The system 100 may be configured to recognize the charging connection 108 (e.g., using image recognition algorithms (e.g., SIFT (Scale-invariant Feature Transform), SURF (Speeded Up Robust Features), PCA (Principal Component Analysis), and LDA (Linear Discriminant Analysis, etc.)) and to display one or more instructions to the driver based on the recognition. The system 100 may display instructions to the driver, for example, such as: “slow to 3 mph,” or “stop,” based on recognition of the charging connection 108. Once the charging connection 108 is within a scope of a narrower field of view 610, the field of view may change to a narrower aspect to give the driver a better view of the charging connection 108. The image data captured by the camera 602 may be displayed on the display 606.

In some embodiments, the arm 104 includes the camera 630, which camera could have similar or distinct characteristics from the cameras 622 (e.g., thermal and/or infrared capabilities, multiple fields of view, etc.). Data captured with the camera 630 can be sent to the bus 102, and vice-versa, via the transceiver 636 and the transceiver 634. Accordingly, the camera 630 can be used to align the bus 102 and/or displayed on the display 606. In some embodiments, the driver can switch between various views captured by the multiple cameras using an input device. For example, in embodiments in which the display 606 is an input/output device, the driver could select which of the multiple views is suitable for aligning the charging head 106 with the charging connection 108.

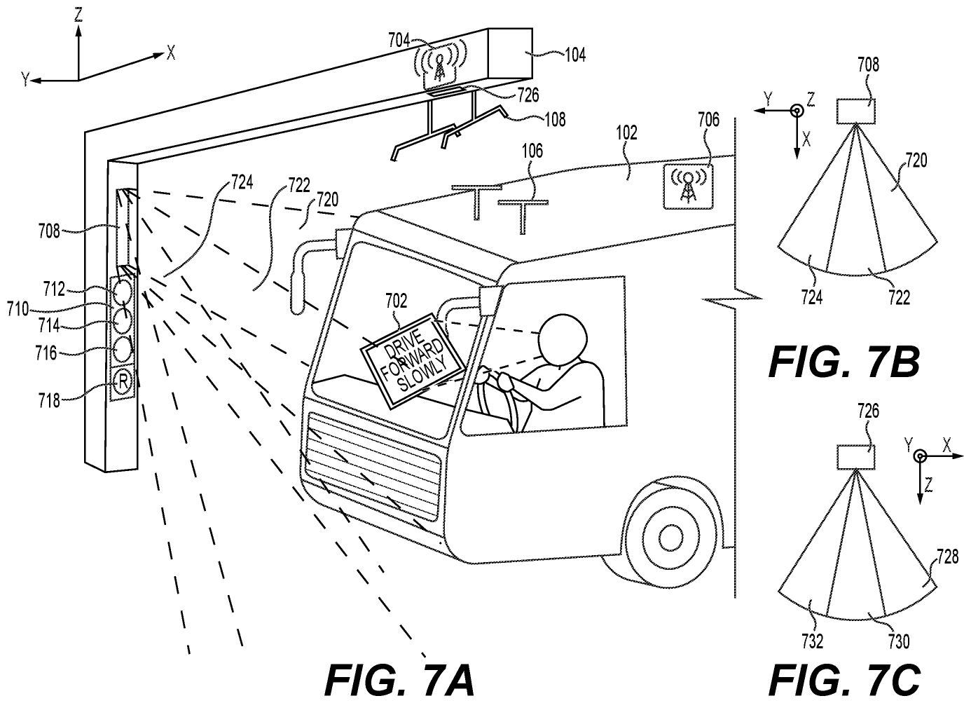

Referring now to FIGS. 7A and 7B, another exemplary embodiment of the system 100 is depicted. FIG. 7B shows the bus 102 and the arm 104 including the charging head 106 and the charging connection 108, respectively. It is noted that the distance between the charging head 106 and the charging connection 108 is not to scale, and the charging head 106 and the charging connection 108 would operatively couple to charge the battery of the bus 102. The bus includes a display 702 which displays an instruction, in this exemplary case, “drive forward slowly,” though any instruction or visual data could be displayed with the display (e.g., imagery from a camera such as any of the cameras shown and described with respect to FIG. 6A). The arm 104 and the bus 102 may include transceivers 704, 706 for sending and receiving data therebetween. The arm 104 includes a sensor 708 and a display 710. The display 710 includes a first indication 712, a second indication 714, a third indication 716, and a fourth indication 718.

FIG. 7B shows a birdseye view of multiple sensor zones created by the sensor 708, which may create for example, a first sensor zone 720, a second sensor zone 722, and a third sensor zone 724 for sensing a location of the bus 102 more precisely with respect to other zones as the bus 102 pulls forward beneath the arm 104. The sensor 708 may include any number or types of sensors, which are configured to send and receive a signal to detect the bus 102. For example, the sensor 708 may be a radar, sonar, lidar, ultrasonic, an RFID, or other sensor. In the particular example embodiment shown in FIGS. 7A and 7B, the sensor 708 is an exemplary lidar sensor.

As discussed above, the sensor 708 may include one or more distinct areas of its sensor field (i.e., zones) and may use the zones to sense the movement of the bus 102 as it moves with respect to the arm 104 and the system 100 may output one or more features based on the sensed location of the bus 102. For example, as the bus 102 pulls beneath the arm 104, the sensor 708 may sense the bus 102 in the first zone 720. Based on the bus 102 detected in the first zone 720, the system 100 may generate a particular response. For example, the display 710 may light a first indication 712 on the arm 104 until the bus 102 is in the first zone 720, and then may light the second indication 714 once the bus 102 is sensed in the first zone 720. The first indication 712 may be, for example, a green light. The second indication 714 may be, for example, a yellow light. The bus 102 may pull forward slowly until it is sensed in the second zone 722, at which point the indication may switch, for example, to a third indication 716. The third indication 716 may be, for example, a red light. The third indication 716 may be configured such that it indicates a driver of the bus 102 should slow and/or stop the bus 102 when the bus 102 is at a point where the charging head 106 and the charging connection 108 could electrically couple. The fourth indication 718 may indicate that the bus 102 is past a coupling point and should travel in reverse and such indication may be displayed to the driver, for example, on the display 702.

Referring to FIGS. 7A, 7B, and 7C, in some embodiments, the arm 104 or other component of the infrastructure may include a second sensor 726 which may be configured to detect a lateral position of the bus 102 with respect to the arm 104. The sensor 726 may be configured to sense in multiple zones such as a first lateral zone 728, a second lateral zone 730, and a third lateral zone 732, as shown in FIG. 7C. The three lateral zones (e.g., a street side zone, a curb side zone, etc.) may be used similarly to the three zones 720, 722, 724 described herein. For example, if the bus 102 is detected in the first lateral zone 728, the system 100 may indicate to the driver that the bus 102 needs to move to the left. If the bus 102 is detected in the third lateral zone 732, it may indicate to the driver that the bus needs to move to the right. If the bus 102 is detected in the third lateral zone 730, it may indicate to the driver that the bus 102 is in a sufficient lateral position to effect electrical coupling between the charging head 106 and the charging connection 108. Hence, the driver may position the bus 102 such that it is sensed in the second zone 722 and the second lateral zone 730. Some embodiments may not have a second sensor 726, but may detect lateral position of the bus 102 with respect to the arm 104 based on a return signal of the first sensor 708. Similarly, some embodiments may not include the first sensor 708, but may detect a position of the bus 102 with respect to the arm 104 using only the second sensor 726.

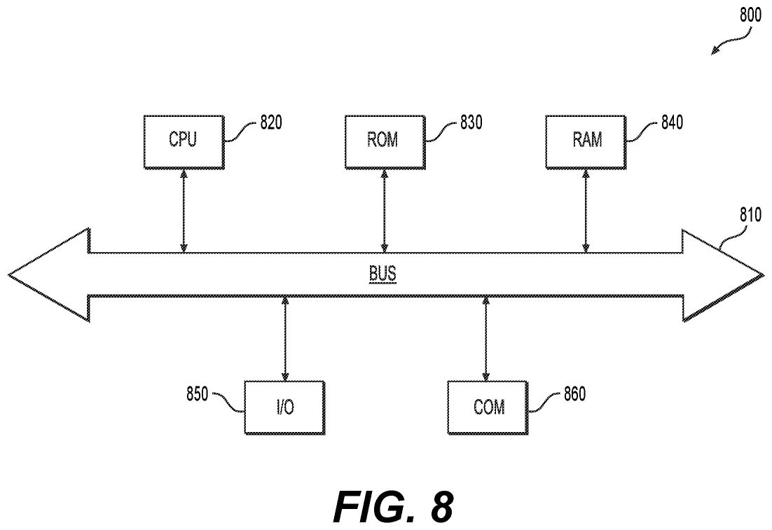

FIG. 8 is a simplified functional block diagram of a computing system 800 that may be configured for carrying out one or more of the steps, programs, and/or executing techniques described herein, according to exemplary embodiments of the present disclosure. Specifically, in one embodiment, any of the modules of controller 300 or the controller 300 itself may be an assembly of software and/or hardware including, for example, a data communication interface 860 for packet data communication. The platform may also include a central processing unit (“CPU”) 820, in the form of one or more processors, for executing program instructions. The platform may include an internal communication bus 810, program storage, and data storage for various data files to be processed and/or communicated by the platform such as ROM 830 and RAM 840, although the system 800 may receive programming and data via network communications. The system 800 also may include input and output ports 850 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

Any suitable system infrastructure may be put into place to allow for the assessment of models monitoring devices. FIG. 8 and the following discussion provide a brief, general description of a suitable computing environment in which certain embodiments and aspects thereof the present disclosure may be implemented. In one embodiment, any of the disclosed systems, methods, and/or graphical user interfaces may be executed by or implemented by a computing system consistent with or similar to that depicted in FIG. 8. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While principles of the present disclosure are described herein with reference to a charging system for charging electric vehicles, such as an electric bus, it should be understood that the disclosure is not limited thereto. The charging system resolves long-felt issues of failure to rapidly and accurately position a charging head on an electric bus in the correct location for electrically coupling the charging head with a charging connection of a charging arm of charging system infrastructure. In some aspects, a reference frame that is common to all vehicle-borne and infrastructure-borne charging connectors is included to facilitate rapidly and accurately an electric bus in the correct location for overhead charging. The multiple sensors of the system and displays can inform an operator of an electric bus where the components of the charging system are with respect to charging system infrastructure, thereby enabling the operator to quickly charge his or her bus. Also, those having ordinary skill in the art and access to the teachings provided herein will recognize additional modifications, applications, embodiments, and substitution of equivalents all fall within the scope of the embodiments described herein. Accordingly, the disclosure is not to be considered as limited by the foregoing description. For example, while certain features have been described in connection with various embodiments, it is to be understood that any feature described in conjunction with any embodiment disclosed herein can be used with any other embodiment disclosed herein.

We claim:

1. A method of charging an electric vehicle comprising:
sensing a relative location of a charging head of the electric vehicle with respect to a charging connection of a charging station using one or more sensors;
generating relative location information related to the relative location; and
displaying information related to the relative location information on a display of the electric vehicle.

2. The method of claim 1, wherein one or more of the one or more sensors comprise one or more of lidar, radar, sonar, RFID, or ultrasonic sensors.

3. The method of claim 1, wherein one or more sensors are mounted on the charging station and one or more sensors are mounted on the electric vehicle.

4. A system for charging an electric vehicle, comprising:
an electric vehicle comprising an electrical system and a rooftop mounted charging head configured to electrically couple with a charging connection of a charging station that comprises an overhead charging arm to charge the electrical system;
one or more sensors;
a display; and
a computing system in communication with the vehicle, the computing system comprising a controller that is operatively coupled to one or more of the one or more sensors and the display, comprising one or more executable instructions that, when executed, cause the system to:
sense a relative location of the charging head with respect to the charging connection using one or more of the one or more sensors;
generate relative location information related to the relative location; and
display information related to the relative location information.

5. The system of claim 4, wherein the display is a display in the electric vehicle.

6. The system of claim 4, wherein one or more sensors are mounted on the charging station and one or more sensors are mounted on the electric vehicle.

7. The system of claim 4, wherein the one or more sensors comprise one or more cameras configured to capture image data of the electric vehicle and the controller is further configure to:
display the image data on the display.

8. The system of claim 7, wherein one or more of the one or more cameras is positioned behind a moveable door or wiper, wherein the moveable door or wiper is moveable to expose a lens of the one or more cameras.

9. The system of claim 4, further comprising an alignment device, wherein
the one or more sensors are configured to sense a position and orientation of the alignment device, and
the relative location information is based on the sensed position and orientation of the alignment device.

10. The system of claim 4, wherein
the charging station comprises at least one charging station sensor, and
the charging station and the electric vehicle are communicatively coupled such that data captured using the at least one charging station sensor is transmitted to the electric vehicle and information displayed on the display of the electric vehicle is based on the data captured using the at least one charging station sensor.

11. The system of claim 10, wherein the at least one charging station sensor comprises at least one camera.

12. The system of claim 10, wherein the at least one charging station sensor is configured to generate one or more sensing zones for sensing a location of the electric vehicle with respect to the charging station and the display is configured to display information to an operator of the electric vehicle based on the sensed location of the electric vehicle within the one or more sensing zones.

13. The system of claim 4, wherein the electric vehicle is an electric bus.

14. An electric vehicle, comprising:
an electrical system;
a mounted charging head for receiving an overhead charging connection of a charging arm to charge one or more batteries of the electrical system;
one or more sensors configured to sense a relative location of the charging head with respect to the charging connection; and
a controller configured to:
capture relative location data from the one or more sensors indicative of a relative location of the electric vehicle charging head with respect to the charging connection; and
present information related to the relative location data to an operator of the electric vehicle.

15. The electric vehicle of claim 14, wherein one or more of the one or more sensors comprise one or more of lidar, radar, sonar, RFID, or ultrasonic sensors.

16. The electric vehicle of claim 14, wherein the electric vehicle is an electric bus, and wherein the one or more sensors comprise at least one camera configured to generate image data and the relative location data is based on the generated image data.

17. The electric vehicle of claim 16, wherein the at least one camera is positioned behind a door and the door is operable to selectively expose the at least one camera based on input from the operator of the electric vehicle.

18. The electric vehicle of claim 16, wherein information displayed to an operator of the electric bus is based on the generated image data.

19. The electric vehicle of claim 14, wherein the information displayed to an operator of the electric vehicle is based on information sensed with the one or more sensors and includes at least one instruction to an operator of the electric vehicle.

20. The electric vehicle of claim 19, wherein the information displayed to an operator of the electric vehicle is based on an alignment device, which alignment device is sensed using one or more sensors.
